(19) United States
(12) Patent Application Publication
(10) Pub. No.: US 2024/0231767 A1
(43) Pub. Date: Jul. 11, 2024

(54) SYSTEMS, METHODS, AND DEVICES FOR PROVIDING A UNIFIED DEBUG AND RENDERING INTERFACE

(71) Applicant: Cypress Semiconductor Corporation, San Jose, CA (US)

(72) Inventors: Prasad Shantanu PRABHUDESAI, Bangalore (IN); Vijay Madhavan, Bangalore (IN)

(73) Assignee: Cypress Semiconductor Corporation, San Jose, CA (US)

(21) Appl. No.: 18/310,662

(22) Filed: May 2, 2023

Related U.S. Application Data
(60) Provisional application No. 63/478,544, filed on Jan. 5, 2023.

(51) Int. Cl. G06F 8/34; B60K 35/00

(52) U.S. Cl. CPC G06F 8/34; B60K 35/00

(57) ABSTRACT

Systems, methods, and devices provide a unified interface for programming and debugging of graphics displays. Methods include receiving a graphical output of a microcontroller unit (MCU) at an interface controller, the graphical output being generated based on graphics program code representing one or more graphical elements. Methods also include generating, using the interface controller, a packetized data stream based on a graphical output, the packetized data stream being generated by wrapping the graphical output in a plurality of data packets, and transmitting the packetized data stream to a host machine used to generate the graphics program code.

### CROSS-REFERENCE TO RELATED APPLICATIONS

This application claims priority under 35 U.S.C. § 119(e) to U.S. Patent Application No. 63/478,544, filed Jan. 5, 2023, which is incorporated by reference herein in its entirety for all purposes.

### TECHNICAL FIELD

This disclosure relates to programming interfaces of graphics microcontrollers, and more specifically, to enhancement of operation of such programming interfaces.

### BACKGROUND

Display devices may be implemented in a variety of different operational environments and using hardware and software with varying levels of processing capabilities. Some implementations may use processing components, such as microcontrollers for graphics processing capabilities with a relatively low power consumption and complexity. Accordingly, application code may be written using one system, and ultimately compiled and implemented in one or more other systems. Conventional techniques for designing, testing, and implementing such code remain limited because they require additional test devices and equipment and do not provide a designer or programmer with direct feedback.

### BRIEF DESCRIPTION OF THE DRAWINGS

FIG. 1 illustrates an example of a graphics computing environment, configured in accordance with some embodiments.

FIG. 2 illustrates another example of a graphics computing environment, configured in accordance with some embodiments.

FIG. 3 illustrates an example of a computing device, configured in accordance with some embodiments.

FIG. 4 illustrates an example of a method for graphics interface management, performed in accordance with some embodiments.

FIG. 5 illustrates another example of a method for graphics interface management, performed in accordance with some embodiments.

FIG. 6 illustrates yet another example of a method for graphics interface management, performed in accordance with some embodiments.

FIG. 7 illustrates a diagram of an example of a unified user interface, configured in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Graphical display devices may be implemented in a variety of contexts. For example, automobiles may include instrument clusters which are actual liquid crystal display (LCD) devices configured to display graphical elements that look like or appear as conventional analog instruments such as a speedometer and tachometer. Such graphical display devices may be configured to display graphical data in accordance with a graphics program. Accordingly, computing system may be used to generate such a graphics program. During a design process, a test system may also be used to test the functionality of a graphics program. Conventional techniques for testing such functionality typically include a target display device. In the previous example, the target display device may be a test version of a display included in the automobile dashboard. Such conventional techniques remain limited because they require the additional implementation of such a test display device, and they do not provide direct and objective feedback to the programmer at the computing system.

Embodiments disclosed herein provide novel feedback paths to a host machine used to generate graphics program code. As will be discussed in greater detail below, an interface controller may be configured to provide a feedback path between a test machine and one or more components of the host machine, such as a software authoring tool as well as a compiler integrated development environment (IDE). The interface controller may perform wrapping and packetizing operations to provide graphical output from the test machine to the host machine as a packetized data stream capable of being received by the host machine. Moreover, the host machine may be configured to generate a novel unified interface that simultaneously displays graphics program code, machine code, as well as an emulated output of a graphics microcontroller unit (MCU) such that they all may be presented to a programmer in a single, unified, and interactive view.

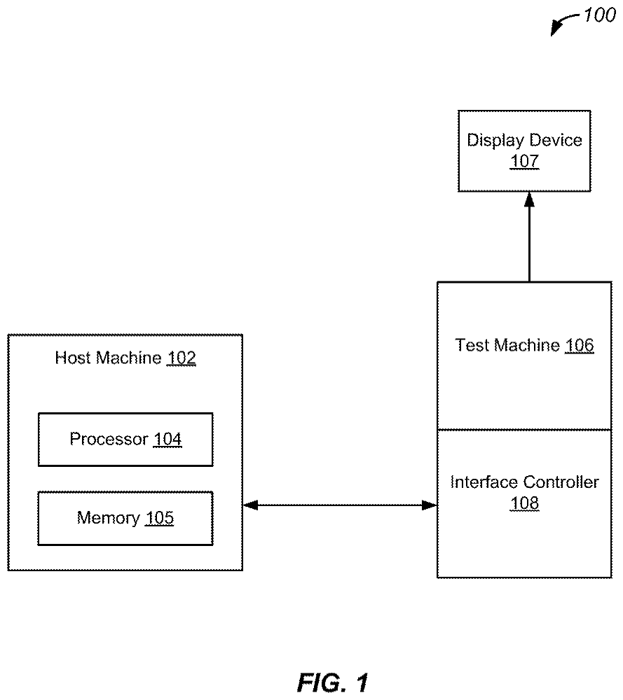

FIG. 1 illustrates an example of a graphics computing environment, configured in accordance with some embodiments. A system, such as system 100, may be configured to provide a unified interface for graphics rendering and debugging. More specifically, system 100 may be configured to provide a feedback path from a graphics MCU to a software authoring tool as well as a compiler to improve the efficiency of modification and debugging of graphics software, and enable such modification and debugging while using fewer hardware resources.

Accordingly, system 100 includes host machine 102 which may be configured to include one or more components to store and execute application software. For example, host machine 102 may include processor 104 and memory 105 configured to execute a graphics software authoring tool. Accordingly, such software may be configured to provide a user with a user interface through which the user may provide inputs to configure and modify graphical elements of a graphical display. In one example, the graphical display may be an instrument cluster of an automobile. Accordingly, the graphics software authoring tool may be used to configure the presentation, appearance, and performance of such an instrument cluster.

System 100 further includes test machine 106 which may include an evaluation board with a graphics MCU. Accordingly, test machine 106 may be a hardware device configured to display graphical content that may be included in an operational environment in which the graphics software will ultimately be deployed. For example, test machine 106 may be configured as hardware used in an automobile to present a display in a dashboard of an automobile, such as an instrument cluster. In some embodiments, test machine 106 is coupled to a target display device, such as display device 107. In one example, display device 107 is a liquid crystal display (LCD) panel.

System 100 additionally includes interface controller 108 which is communicatively coupled to test machine 106 and host machine 102. As will be discussed in greater detail below, interface controller 108 is configured to provide a program and debug interface between host machine 102 and test machine 106. Interface controller 108 is also configured to provide a feedback path between test machine 106 and host machine 102 such that a real output of a graphics MCU included in test machine 106 is encapsulated and fed back to host machine 102 as a data stream that may be processed by host machine 102. Accordingly, the feedback provided by interface controller 108 enables host machine 102 to display the output of test machine 106 in a single user interface as the graphics software authoring tool and compiler IDE executed on host machine 102, and does not require use or inspection of display device 107.

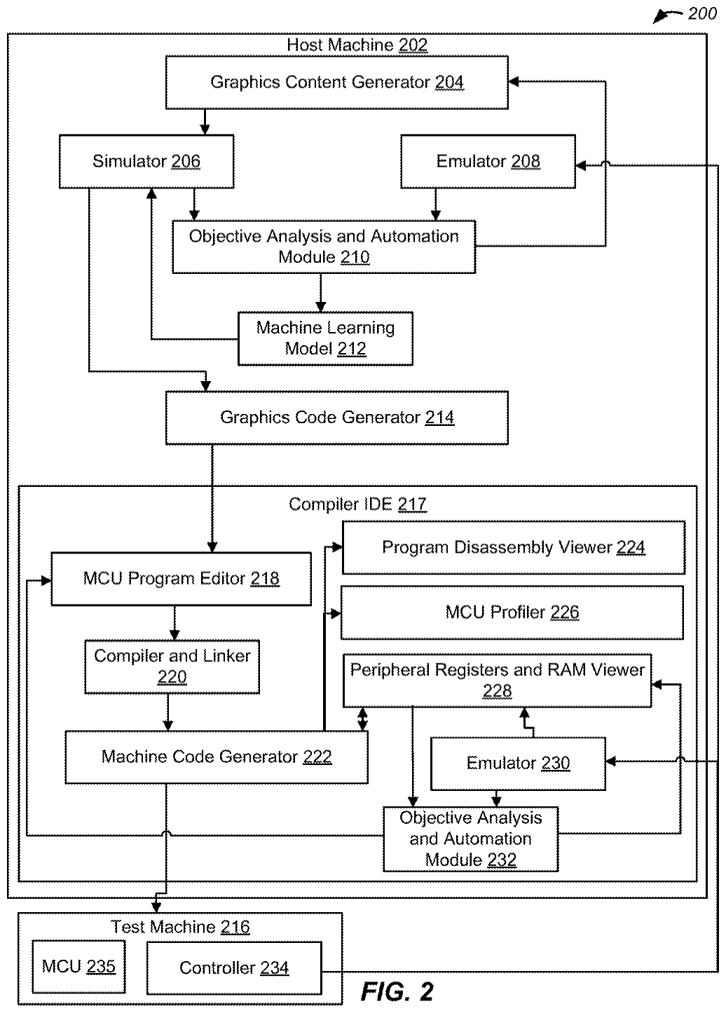

FIG. 2 illustrates another example of a graphics computing environment, configured in accordance with some embodiments. As similarly discussed above, a system, such as system 200, may be configured to provide a unified interface for graphics rendering and debugging. More specifically, system 200 may be configured to provide a feedback path from a target graphics MCU to a software authoring tool and/or a compiler IDE to improve the efficiency of modification and debugging of graphics software, and enable such modification and debugging while using fewer hardware resources.

System 200 includes host machine 202 which is configured to include one or more components to store and execute application software. More specifically, host machine 202 includes graphics content generator 204 which is configured to generate graphics data that is intended for display at a target display device. Accordingly, graphics content generator 204 may be configured to execute a software authoring tool. Graphics content generator 204 may be communicatively coupled to simulator 206 which is configured to simulate the behavior of an evaluation board and a target display device. Accordingly, simulator 206 is configured to provide simulated results of an output of a graphics MCU of test machine 216 generated based on an output of graphics content generator 204.

Host machine 202 may also include objective analysis and automation module 210 which may be configured to automate one or more changes and/or modifications to the graphics program code. Such changes and/or modifications may be determined based on a set of rules included in a rules engine. Such changes may also be user-defined, and thus used to implement changes and modifications, as will be discussed in greater detail below. In various embodiments, objective analysis and automation module 210 is configured to compare an actual graphical output of a graphics MCU with a desired or target output represented by simulator 206. Accordingly, adjustments may be made to content, sizes, shapes, colors, and other visual attributes based on pixel-data comparison rather than by visual perception. Such adjustments may be made in the context of, for example, deploying scripts on host machine 202 to verify if every pixel of every frame has the correct content as designated by graphics content generator 204. Such adjustments may be made in the context of deploying scripts on host machine 202 to identify any glitches and/or artefacts on the display. Such adjustments may be made in the context of deploying scripts on host machine 202 to ensure that there are no missed frames in a graphical output. In some embodiments, it is possible to use automation for functional validation of display content, or to run stress tests on a graphics MCU.

In various embodiments, objective analysis and automation module 210 is communicatively coupled to machine learning model 212 which may be configured to make one or more changes to simulator 206 based on changes identified by objective analysis and automation module 210, thus improving performance of simulator 206. More specifically, machine learning model 212 may be configured to deploy one or more machine learning models that may be used by simulator 206 to improve its output based on iterative comparisons between an output of simulator 206 and an output of emulator 208 received via a feedback path. In one example, machine learning model 212 may include one or more supervised machine learning models that use the output of emulator 208 as training data. In this way, machine learning model 212 provides learning capabilities that enable simulator 206 to improve its performance and approximate behavior of emulator 208 and an output of a graphics MCU.

Host machine 202 additionally includes graphics code generator 214 which is configured to render graphical data, such as portions of the graphics program code. Thus, according to various embodiments, graphics code generator 214 is configured to generate user interfaces as disclosed herein. More specifically, graphics code generator 214 is configured to generate a unified user interface that simultaneously displays graphics program code, machine code corresponding to the graphics program code, and a rendered result of the machine code. It will be appreciated that the unified user interface may also display simulation data generated by simulator 206.

In various embodiments, system 200 additionally includes compiler IDE 217 which is configured to receive an output from graphics code generator 214. Accordingly, compiler IDE 217 may receive graphics program code from host machine 202, and may merge the graphics program code with other non-graphics program components, and compile the merged program code into machine code. In some embodiments, compiler IDE 217 may include MCU program editor 218 which is configured to support some editing capabilities for the graphics program code. For example, MCU program editor 218 is configured to edit program code and provide compiling functionality to generate machine code. The resulting machine code is then downloaded into the program memory of the graphics MCU and executed. Compiler IDE 217 additionally includes compiler and linker 220 which are configured to perform compiling and linking operations for the graphics program code, and machine code generator 222 which is configured to generate the machine code.

In various embodiments, machine code generator 222 is coupled to various other components, such as program disassembly viewer 224, MCU profiler 226, and peripheral registers and RAM viewer 228 which are configured to provide various visibility and debugging capabilities for compiler IDE 217 and an implementation of machine code. Compiler IDE 217 may also include emulator 230 that may be configured to emulate a target display device. Compiler IDE 217 may further include objective analysis and automation module 232 which may be configured to implement modifications and updates to program code via MCU program editor 218, and may be further configured to implement modifications and updates at a register level via peripheral registers and RAM viewer 228. In this way, register-level modifications may be made and may be immediately viewable in a unified user interface.

System 200 further includes interface controller 234. As shown in FIG. 2, interface controller 234 includes processing elements that are configured to receive machine code from machine code generator 222, and is further configured to provide an output to one or more emulator instances, such as emulator 208 and emulator 230. Accordingly, interface controller 234 is configured to receive the machine code to provide a program/debug interface between host machine 202, and more specifically compiler IDE 217, and test machine 216. Moreover, a real graphical output of a graphics MCU, such as graphics MCU 235, is fed back to emulator 208 and emulator 230 of host machine 202. As used herein, processing elements may refer to processing logic implemented in hardware and/or software as may be supported by a programmable logic device, firmware, or any other suitable processor or processing device.

In various embodiments, interface controller 234 is configured to perform programming and debugging of graphics MCU 235 based on the machine code received from machine code generator 222. Interface controller 234 also performs wrapping operations to wrap a graphical output in data packets that may be transmitted as a packetized data stream to host machine 202. For example, the graphical output of graphics MCU 235 may be partitioned into data chunks corresponding to data payloads, and each of the data chunks may be encapsulated in data packets. The data packets may have a format determined based on reception parameters of host machine 202. For example, such reception parameters may be a format or standard associated with a data port. Accordingly, wrapping operations may convert data into a format that is accepted by a communications standard such as USB, Ethernet, or any other suitable communications standard, and that may be carried by a standard interface cable between test machine 216 and host machine 202. In one example, interface controller 234 is a universal serial bus (USB) controller. More specifically, interface controller 234 may be an FX3 USB controller, and the wrapping operations and data packets may be configured for transmission via a USB port.

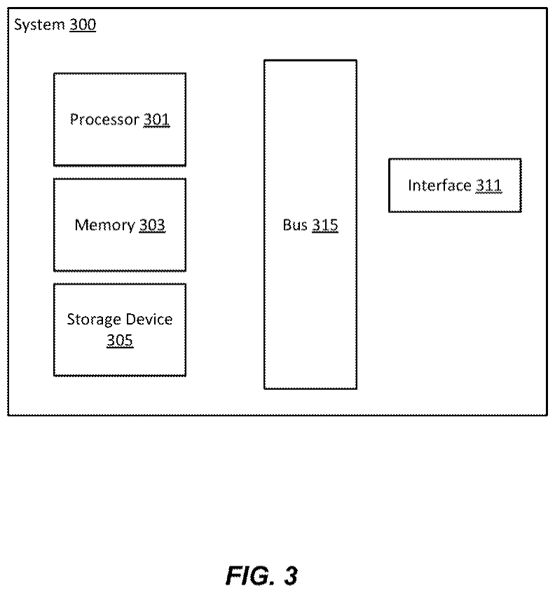

FIG. 3 illustrates one example of a computing system. According to various embodiments, system 300 may be suitable for implementing embodiments described herein. For example, system 300 may be used to implement host machine 102 or interface controller 108 described above. In various embodiments, system 300 includes processor 301, memory module 303, storage device 305, interface 311, and bus 315 (e.g., a PCI bus or other interconnection fabric). As discussed above, system 300 may operate as a variety of systems and/or devices described herein. Although a particular configuration is described, a variety of alternative configurations are possible. Processor 301 may perform operations such as those described herein. Instructions for performing such operations may be embodied in memory 303, on one or more non-transitory computer readable media, or on some other storage device. Various specially configured devices can also be used in place of or in addition to processor 301. Interface 311 may be configured to send and receive data packets over a network. Examples of supported interfaces include, but are not limited to: USB, Ethernet, fast Ethernet, Gigabit Ethernet, cable, digital subscriber line (DSL), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed embodiments may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks, optical media such as flash memory, compact disk (CD) or digital versatile disk (DVD), and other hardware devices such as read-only memory (“ROM”) devices and random-access memory (“RAM”) devices. A computer-readable medium may be any combination of such storage devices.

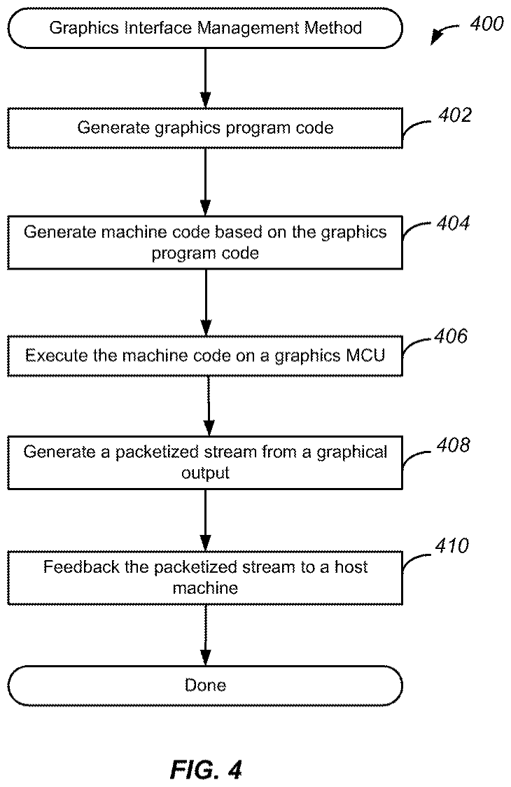

FIG. 4 illustrates an example of a method for graphics interface management, performed in accordance with some embodiments. A method, such as method 400, may be performed to provide a unified interface for graphics rendering and debugging. As similarly discussed above, method 400 may be performed to provide a feedback path from a test machine to a software authoring tool and/or a compiler IDE to improve the efficiency of modification and debugging of graphics software, and enable such modification and debugging while using fewer hardware resources.

Method 400 may perform operation 402 during which graphics program code may be generated. As similarly discussed above, the graphics program code may be generated, at least in part, by a host machine based on input received from a user via an input device, or based on previously generated application code. Accordingly the graphics program code may include code representing one or more graphical elements included in a target display device, such as dials in an instrument cluster of an automobile. The graphics program code may also represent functionalities associated with such graphical elements. Thus, the graphics program code may be a representation of portion of an executable code that provides representation and functionality of various graphical elements included in the target display device.

Method 400 may perform operation 404 during which machine code may be generated based on the graphics program code. As discussed above, the graphics program code may be generated using a graphics authoring tool, and the graphics program code may be compiled to generate machine code that may be executed by a graphics MCU in a test machine. In various embodiments, a compiler may be used to generate the machine code.

Method 400 may perform operation 406 during which the machine code may be executed by a graphics MCU. Accordingly, the machine code may be executed by the graphics MCU, and the graphics MCU may generate a graphical output based on the execution of the machine code.

Method 400 may perform operation 408 during which a packetized data stream may be generated based on the graphical output. In various embodiments, an interface controller may be used to generate the packetized data stream. As will be discussed in greater detail below, the interface controller may receive the graphical output from the graphics MCU, and may wrap the graphical output in data packets capable of being transmitted back to the host machine. Accordingly, the graphical output of the graphics MCU may also be packetized as a data stream that is compatible with one or more data ports of the host machine.

Method 400 may perform operation 410 during which the packetized data stream may be fed back to a host machine. In some embodiments, the packetized data stream may be transmitted using a standard debug interface, or may be transmitted using a dedicated interface separate from a standard debug interface. In this way, a component, such as the interface controller, may provide a direct feedback path between the graphics MCU and the host machine so that the host machine may be provided with the graphical output of the graphics MCU as a result of the executed machine code, and may also determine if additional modifications or updates should be made, as will be discussed in greater detail below.

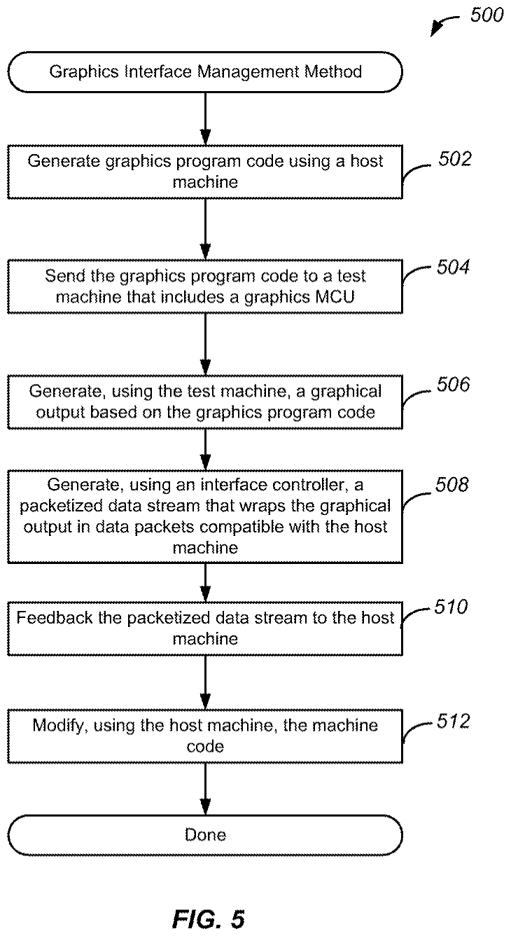

FIG. 5 illustrates another example of a method for graphics interface management, performed in accordance with some embodiments. A method, such as method 500, may be performed to provide a unified interface for graphics rendering and debugging. As similarly discussed above, method 500 may be performed to provide a feedback path from a graphics MCU to a software authoring tool as well as a compiler IDE to improve the efficiency of modification and debugging of graphics software. As will be discussed in greater detail below, the unified interface may enable updating and modification of the graphics software at the host machine without the need for validation from a target display device.

Method 500 may perform operation 502 during which graphics program code may be generated using a host machine. As similarly discussed above, the graphics program code may be generated, at least in part, by a host machine based on input received from a user via an input device, or based on previously generated application code. Thus, the host machine may host and execute a software authoring tool that is configured to enable a user to write and modify application code. In various embodiments, the graphics program code may include code representing one or more graphical elements included in a target display device, such as dials in an instrument cluster of an automobile. The graphics program code may also represent functionalities associated with such graphical elements. Thus, the graphics program code may be a representation of portion of an executable code that provides representation and functionality of various graphical elements included in the target display device.

Method 500 may perform operation 504 during which the graphics program code may be sent to a test machine that includes a graphics MCU. Accordingly, the graphics program code generated by the software authoring tool may be compiled by a suitable IDE and sent to a test machine, such as an evaluation board, that includes a graphics MCU. As discussed above, the graphics program code may be sent via an interface, which may be a unified interface managed by an interface controller.

Method 500 may perform operation 506 during which a graphical output may be generated by a test machine based on the graphics program code. As discussed above, the graphics program code may be transmitted to test machine that includes a graphics MCU. As also discussed above, the host machine may include a compiler IDE that is configured to compile the graphics program code into machine code that may be executed by a graphics MCU. Accordingly, during operation 506, the compiler may compile the graphics program code into machine code that is executable by a graphics MCU of the test machine to generate a graphical output.

Method 500 may perform operation 508 during which a packetized data stream may be generated based on the graphical output by wrapping the graphical output in data packets compatible with the host machine. As similarly discussed above, the interface controller may be configured to generate the packetized data stream in which data is included in data packets and transmitted in accordance with one or more transmission protocols. Accordingly, the interface controller may also receive the graphical output of the graphics MCU from the test machine, and may wrap the graphical output in data packets capable of being transmitted back to the host machine. More specifically, the graphical output may be packetized in data packets that are compatible with one or more data ports of the host machine. The data packets may collectively form a data stream.

Method 500 may perform operation 510 during which the packetized data stream may be fed back to the host machine. Accordingly, the data packets generated during operation 508 may be sent to the host machine as a data stream. In this way, a component, such as the interface controller, may provide a direct feedback path between the graphics MCU and the host machine so that the host machine may be provided with the compiled machine code as well as a result of the executed machine code.

Method 500 may perform operation 512 during which the machine code may be modified at the host machine. Accordingly, the payloads of the received data packets may be used to reconstruct the graphical output of the graphics MCU, and the host machine may use an emulator to visualize the received graphical output. The emulator may also be used to generate a graphical representation, such as a graphical interface, based on the machine code. In this way, an output of the graphics MCU may be displayed in a unified interface on the host machine such that a direct output of the graphics MCU is visible at the host machine. Moreover, an entity, such as a user, may observe the unified user interface, and determine if one or more modifications should be made. As will be discussed in greater detail below, such modifications may be entered via a debug panel which is configured to enable the graphics program code to be modified.

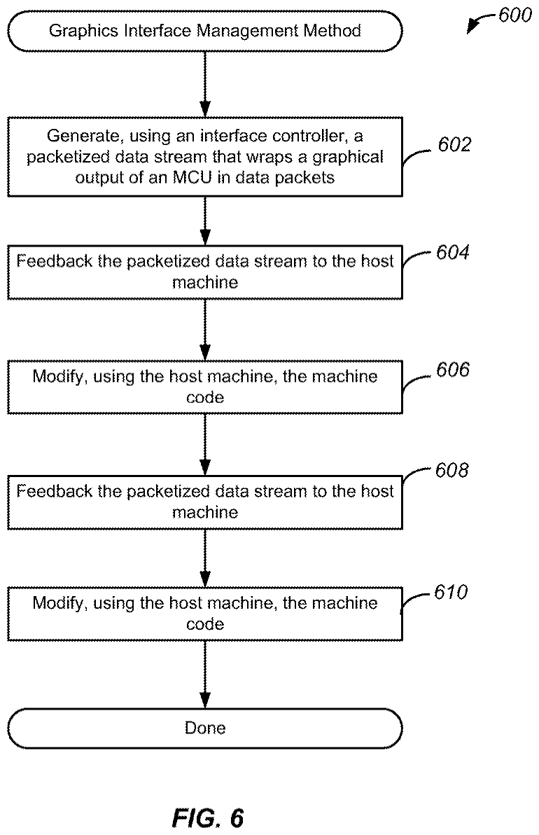

FIG. 6 illustrates yet another example of a method for graphics interface management, performed in accordance with some embodiments. A method, such as method 600, may be performed to provide a unified interface for graphics rendering and debugging. As similarly discussed above, method 600 may be performed to provide a feedback path from a graphics MCU to a software authoring tool and/or a compiler IDE to improve the efficiency of modification and debugging of graphics software. As will be discussed in greater detail below, an iterative process of updating and modifying graphics program code may be performed at a host machine without the need for validation via a target display device.

Method 600 may perform operation 602 during which a packetized data stream may be generated based on a graphical output of a graphics MCU by wrapping the graphical output in data packets compatible with a host machine. As similarly discussed above, an interface controller may be configured to generate a packetized data stream in which data is included in data packets and transmitted in accordance with one or more transmission protocols. Accordingly, the interface controller may also receive graphical output of the graphics MCU from a test machine, and may wrap the graphical output in data packets capable of being transmitted back to the host machine. More specifically, the graphical output may be packetized in data packets that are compatible with one or more data ports of the host machine. The data packets may collectively form a data stream.

Method 600 may perform operation 604 during which the packetized data stream may be fed back to a host machine. Accordingly, the data packets generated during operation 602 may be sent to the host machine as a data stream. In this way, a component, such as the interface controller, may provide a direct feedback path between the graphics MCU and the host machine so that the host machine may be provided with the compiled machine code as well as a result of the executed machine code.

Method 600 may perform operation 606 during which the machine code may be modified at the host machine. As similarly discussed above, the payloads of the received data packets may be used to reconstruct the graphical output of the graphics MCU, and the host machine may use an emulator to visualize the received packetized graphical output. The emulator may also be used to generate a unified user interface based on the graphical output of the graphics MCU. An entity, such as a user, may observe the unified user interface, and determine if one or more modifications should be made. Such modifications may be entered via a debug panel which is configured to enable the graphics program code to be modified. In various embodiments, the modified machine code may be again be sent to the graphics MCU which may execute the updated machine code.

Method 600 may perform operation 608 during which the packetized data stream may be fed back to a host machine. Accordingly, the interface controller, may again wrap the updated graphical output of the graphics MCU such that it is packetized in a data stream. As similarly discussed above, the packetized data stream including the wrapped updated graphical output may be fed back to the host machine via the interface controller.

Method 600 may perform operation 610 during which the machine code may be executed by the test machine and fed back to the host machine. Accordingly, the payloads of the received data packets may again be used to reconstruct the graphical output, and the host machine may use an emulator to visualize the received graphical output. The emulator may again generate a unified user interface based on the machine code. Thus, an entity, such as the user, may be presented with an updated representation of the result of the execution of the machine code by observing the unified user interface. In this way, additional modifications and updates implemented by a user may be used to update machine code and also update, via the feedback path provided by the interface controller, the representation of such machine code in the unified interface.

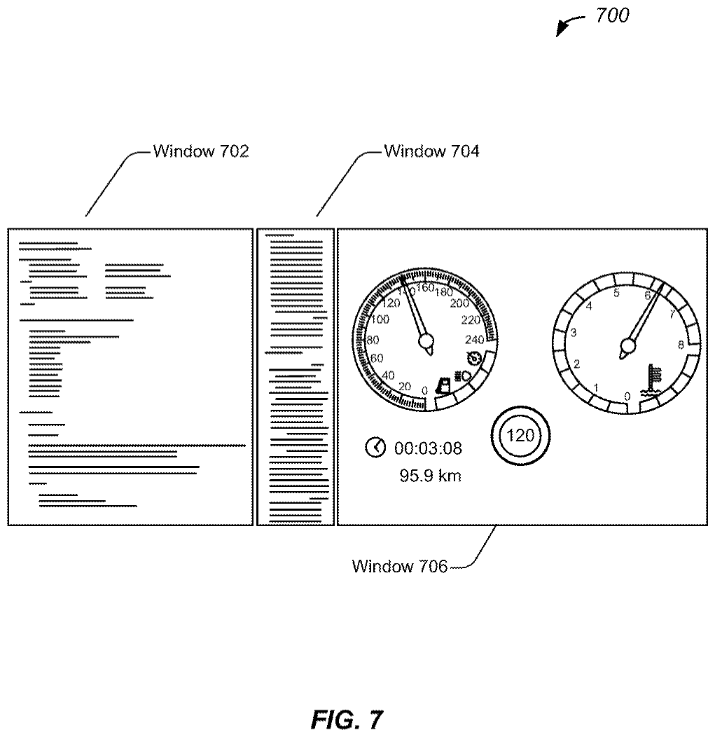

FIG. 7 illustrates a diagram of an example of a unified user interface, configured in accordance with some embodiments. As similarly discussed above, user interface 700 may provide a unified view of a software authoring tool and/or compiler IDE, corresponding machine code, as well as a graphical output resulting from execution of the machine code. More specifically, user interface 700 may include window 702 which is configured to provide a user interface for a software authoring tool and/or compiler IDE. Accordingly, window 702 may receive input from a user that is used to write and modify graphics program code via the software authoring tool and/or the compiler IDE.

In various embodiments, user interface 700 further includes window 704 which illustrates machine code corresponding to the graphics program code and other IDE features such as memory window, register status of MCU registers, CPU profiler, etc. As discussed above, a subset of the data being displayed in some parts of window 704 may have been fed back to the host machine via the standard debug interface. Moreover, the emulator also provides the view of the output of the graphics MCU in window 706. It is now possible to click and modify the MCU register values in real-time and observe instantly the effect such modifications have on the graphical output generated by the emulator.

As noted above, user interface further includes window 706 which illustrates a graphical output that results from execution and implementation of the machine code on the graphics MCU. In the example shown in FIG. 7, window 706 provides a view of an instrument cluster that may be present in the dashboard of an automobile. Accordingly, window 706 is configured to provide a view of a final graphical output of the graphics program code as it would be displayed on a target display device if such a target display device were used.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
receiving a graphical output of a microcontroller unit (MCU) at an interface controller, the graphical output being generated based on graphics program code representing one or more graphical elements;
generating, using the interface controller, a packetized data stream based on a graphical output, the packetized data stream being generated by wrapping the graphical output in a plurality of data packets; and
transmitting the packetized data stream to a host machine used to generate the graphics program code.

2. The method of claim 1, wherein the generating of the packetized data stream further comprises:
partitioning the graphical output into a plurality of data payloads; and
encapsulating each of the plurality of data payloads in a data packet.

3. The method of claim 2, wherein a format of each data packet is determined based on one or more reception parameters of a host machine.

4. The method of claim 1 further comprising:
generating a user interface based on at least a portion of the graphics program code, associated machine code, and the packetized data stream.

5. The method of claim 4, wherein the user interface is configured to provide a unified view of the graphics program code, the machine code, the packetized data stream, MCU register values, and one or more IDE features.

6. The method of claim 5 further comprising:
generating a graphical representation of a target display device based on the packetized data stream.

7. The method of claim 6, wherein the target display device is a display device of an automobile.

8. The method of claim 5 further comprising:
receiving a modification via the user interface.

9. The method of claim 1 further comprising:
transmitting the packetized data stream to a compiler included in the host machine.

10. A system comprising:
a host machine comprising processing elements configured to generate graphics program code representing one or more graphical elements;
a test machine comprising an MCU and processing elements configured to generate a graphical output based, at least in part, on the graphics program code; and
an interface controller comprising processing elements configured to:
receive the graphical output from the test machine;
generate a packetized data stream based on a graphical output, the packetized data stream being generated by wrapping the graphical output in a plurality of data packets; and
transmit the packetized data stream to the host machine.

11. The system of claim 10, wherein the interface controller is further configured to:
partition the graphical output into a plurality of data payloads; and
encapsulate each of the plurality of data payloads in a data packet.

12. The system of claim 11, wherein a format of each data packet is determined based on one or more reception parameters of a host machine.

13. The system of claim 10, wherein the host machine is further configured to:
generate a user interface based on at least a portion of the graphics program code, associated machine code, and the packetized data stream.

14. The system of claim 13, wherein the user interface is configured to provide a unified view of the graphics program code, the machine code, and the packetized data stream.

15. The system of claim 14, wherein the host machine is further configured to:
generate a graphical representation of a target display device based on the packetized data stream.

16. A device comprising:
an interface controller comprising processing elements configured to:
receive a graphical output of an MCU, the graphical output being generated based on graphics program code representing one or more graphical elements;
generate a packetized data stream based on the graphical output, the packetized data stream being generated by wrapping the graphical output in a plurality of data packets; and
transmit the packetized data stream to a host machine used to generate the graphics program code.

17. The device of claim 16, wherein the interface controller is further configured to:
partition the graphical output into a plurality of data payloads; and
encapsulate each of the plurality of data payloads in a data packet.

18. The device of claim 17, wherein a format of each data packet is determined based on one or more reception parameters of a host machine.

19. The device of claim 16, wherein the processing elements are further configured to:
generate a user interface based on at least a portion of the graphics program code, associated machine code, and the packetized data stream generated based on the graphical output of the MCU.

20. The device of claim 19, wherein the user interface is configured to provide a unified view of the graphics program code, the machine code, and the packetized data stream.
